(19) United States
(12) Patent Application Publication
(10) Pub. No.: US 2008/0281644 A1
(43) Pub. Date: Nov. 13, 2008

(54) Seat selection method for event tickets

(76) Inventor: Andrew Payne, Lincoln, MA (US)

Correspondence Address: Goodwin Procter LLP;Attn: Patent Administrator, 135 Commonwealth Drive, Menlo Park, CA, 94025-1105, US

(21) Appl. No.: 12/118,391

(22) Filed: May 9, 2008

Related U.S. Application Data
(60) Provisional application No. 60/928,667, filed on May 11, 2007.

(51) Int. Cl. G06Q 10/00

(52) U.S. Cl. 705/5

(57) ABSTRACT

A method is provided for assisting users select seats for an event using a user interface to select a seat. The user interface includes at least one of, a price range slider, a number of seat selector, a seat ranking selector, a table of available seats and a venue map.

### CROSS-REFERENCE TO RELATED APPLICATIONS

This application claims the benefit of U.S. Ser. No. 60/928,667 filed May 11, 2007, which application is fully incorporated herein by reference.

### BACKGROUND OF THE INVENTION

1. Field of the Invention

This invention relates generally to the purchase of tickets, and more particularly to interface methods for assisting users find and select seats for a given event.

2. Description of the Related Art

Customers that buy tickets for events (e.g. sporting events, concerts, plays, etc.) want to choose the best seats for the budget they can afford. Most events have a range of seats available at a range of prices—the better seats (typically closer to the performer or field) cost more.

When buying tickets on-line, customers frequently need help understanding what kind of seats they're getting, which helps the customer make a purchase decision when several seating options are available.

### SUMMARY OF THE INVENTION

An object of the present invention is to provide improved methods for users to select seats to a given event.

Another object of the present invention is to provide user interface methods for helping users find and choose seats for a given event

These and other objects of the present invention are achieved in a for assisting users select seats for an event using a user interface to select a seat. The user interface includes at least one of, a price range slider, a number of seat selector, a seat ranking selector, a table of available seats and a venue map.

### BRIEF DESCRIPTION OF THE DRAWINGS

FIG. 1 depicts a general implementation of the user interface.

FIG. 2 depicts a price slider graph of the present invention.

### DETAILED DESCRIPTION OF THE PREFERRED EMBODIMENTS

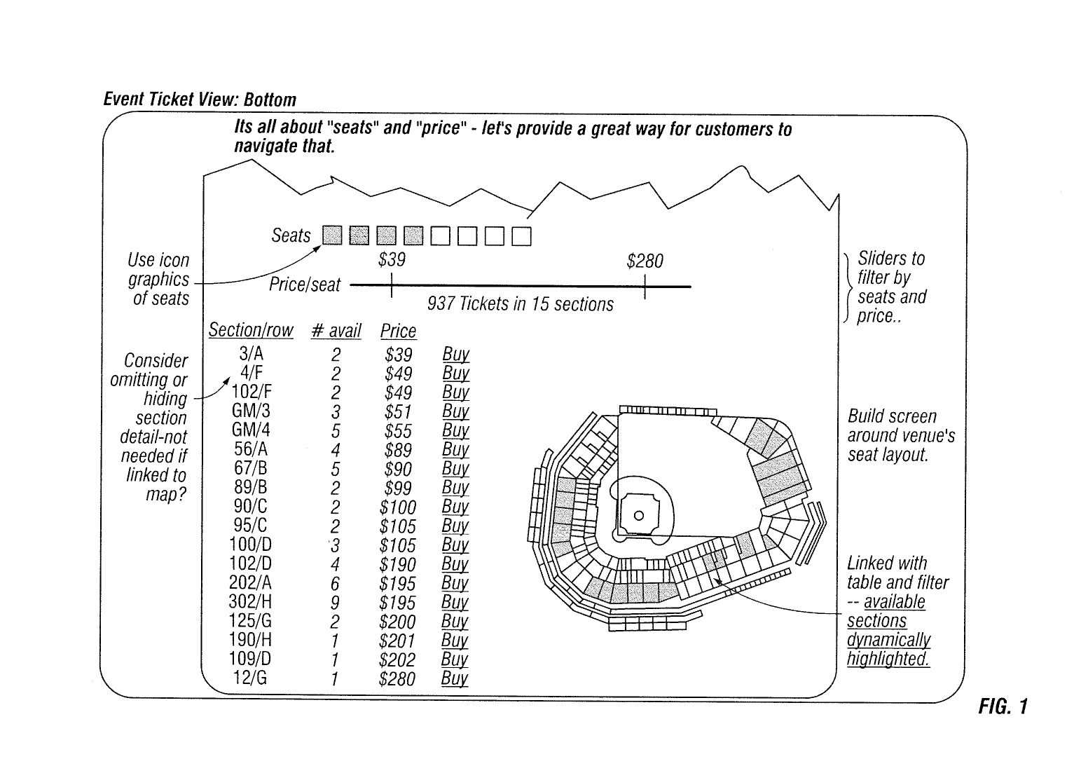

This invention presents user interface methods for helping users finds and choose seats for a given event. A general view of one implementation of the user interface is shown in FIG. 1.

### UI Components

Price range slider. This slider defines the user's budget (minimum price and maximum price). The user may drag the low end (e.g. $39 in the above example) or the high end (e.g. $280 in the above example) of the price range slider to change the price ranges.

Number of seats selector. This selector defines how many seats the user wants to buy (e.g. 2, 3, 4, etc.) The system will constrain the available seats presented to options that include the user's selected number of contiguous seats.

Seat ranking selector (not shown on FIG. 1). If the system implements a seat ranking system (e.g. grading seat quality in a range, say from 0 to 5), the system may allow the user to only choose seats that are in a ranking quality range (e.g. “show me seats that are only ranked 5 stars”). See other disclosures for methods of ranking seat quality.

Table of available seats (ticket information table). This table presents the list of available seats, for a section (or set of sections) being considered by the user. (See the venue map, next section).

Venue map. This selector shows a picture of the venue (e.g. Fenway Park). Sections with available seats (based on the user's criteria) may be highlighted using a variety of methods, including but not limited to highlighted color, a highlight band around the section, etc. Similarly, sections without available seats may be “de-highlighted” (e.g. dimmed).

In addition, the venue map may be active. When the user does a mouse-over or selection, the system may show additional information about the section and/or the seats available in that section. That information may include the number of seats available, the price range (minimum and maximum) of available seats; the list of all seat groups available in that section, with information on: exact row and section detail, any notes about the seats, price, and broker/vendor selling those seats.

This additional information may be displayed in a side window on the page, or in a pop-up/hover window or any combination. If displayed in a side window, the system may display a visual connection on the venue map between the section and the side window with detailed seat data.

Additional methods for the venue map are described in a following section.

### Other UI Methods

Real-time updating based on user input. When the user changes any information (e.g. the price range slider, or the number of seats available, etc.), the information on the screen about available seats is updated in real-time or near-real time. This information may include a summary of available seats (e.g. “121 tickets available”) and information about what sections are available (e.g. highlighted on the venue map).

Selecting multiple sections. The system may provide methods for the user to select multiple sections, so that all available ticket data from those sections may be combined into a single list of tickets (for comparison). The selection may be done with any number standard methods, such as “CNTRL-{mouse click}”.

URL representing the full state of the view. The system may provide a URL that provides the full state or nearly full state of the view (e.g. a “link to this page” option). This will allow a user to research some ticket options, capture a URL that summarizes them, and email or IM that URL to other users to review.

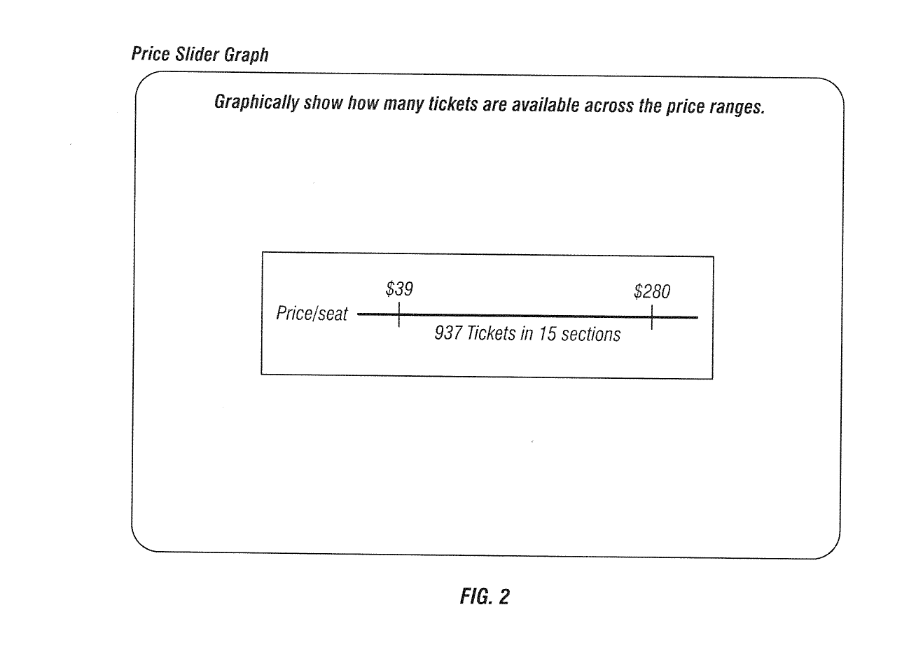

Price-slider availability graph. The price slider used to select the low and high end of the user's budget may include a graph showing the number of seats at various price ranges, as shown in FIG. 2.

The height of the bars is proportional to the number of seats available at that price. This graph lets the user quickly visualize at what price(s) the available seats are. The price/availability graph may also support mouse-overs for detail, showing the detail of the seats available at different prices. It may also visually highlight (e.g. using a different color) prices that are outside of the user's select low and high range.

The price availability may be tied to other constraints or filters. For example, if the user chooses the seat selector for “4 seats”, then the price/availability graph may only show seats that are available in blocks of 4 our greater.

### Venue Map Methods

Additional methods for the venue map include are summarized here. These methods may be used in any combination.

Zoom levels. The system may allow the user to zoom in on the venue map to see more detail (and then zoom out to see the whole venue). In cases where scalable vector graphics are not available, the system may implement this by pre-rendering venue maps and associated graphics at all possible zoom levels.

Not all detail may be shown at all zoom levels. For example, the system may omit seat level detail (below) when zoomed out beyond a given threshold.

Section level detail. The sections on the venue map may include additional detail information, including any combination of number of seats available in that section; price range of seats available (min and max); average or median price of seats; historical pricing information for that section.

Seat level detail. The system may provide seat level detail in a section, showing not only the layout of a section but the location and orientation of every seat within that section. The seat level detail may not be displayed when zoomed out beyond a threshold (see above).

The seat level detail may additional detail information, including but not limited to highlighted availability. Individual seats that are available may be highlighted, just as sections with seats available are highlighted.

Pricing information. Seats may include pricing information, including any combination of price for seats available for purchase; for seats that are not available, show the price that the seat sold for; the ticket price for the seat; the historical price for the seat (average, min, max, price from the previous game or event).

Highlighting of selected seats. When the user selects a set or set of seats, the system may visually highlight those seats in the venue map. If the venue map has seat level detail, the system will highlight the individual seats. If seat level detail is not available, the system may estimate the seat location within the seating section. This can be done by assuming that the seats are laid out with relatively regular spacing. If the number of rows and section width is known, then the location of a given seat can be estimated by linear interpolation.

Top-down photos. If top-down photos of the venue are available, the system may display those views to the user, in addition to a venue and section map. Those photos may be used any place a section map is used, and all of the methods described here (e.g. section and seat highlighting, zoom, etc.) may work with the photos. In addition, the system may provide a method for the user to switch between a venue map view and a photo view. When that switch is done, the views will be aligned (e.g. when switching from a map to a photo, the system will display the exact same zoom level and location in the photo that the user was looking at in the view).

### Large Group Support

In some cases, a user wants to buy a larger block of tickets (e.g. 8) that aren't available in a single, contiguous ticket group. In this case, the system may find groups of tickets that are nearby to each other, giving the user an option to purchase their block.

The system may determine “nearby” by considering the following.

Adjacency by rows. Most tickets are sold in blocks which are side-by-side adjacent. The system may find contiguous seats by row (e.g. 2 seats in row J, with two seats behind in row K).

Section. The system may consider seats to be nearby if they are in the same section.

Physical distance between seats. If the system knows the relative location of every seat in the venue (or can interpolate the relative location, see “highlighting of selected seats”, above). This approach would help find group seating options that are nearly adjacent: for example, seats across an aisle in the same row but in different sections.

Searching for larger groups of non-adjacent seats may be a user search option that the user can enable or disable. This option may be presented if the user searches for a larger group, and there are few or no adjacent seat options. For example, if a user searches for 8 seats, and there is only one block available, the system may offer the user an option to “Expand to search for 8 seats in a nearby group?”

### Presentation of Previous Purchase Seat Data

If a user has purchased before, the system may present information about those previous purchases when looking at seats in the same venue. These presentations may include:

Highlighting of previous seats on the venue seat map. The highlighting may include information about the previous purchase (e.g. “You bought these seats 4 weeks ago for the Braves game, and paid $100/seat”), presented on the venue map, or in a hover window, or in the ticket information table.

Summary of previous seats, with information about current availability. The system may present a table of previously purchased seats. If the seats are currently available, the system may present current price. If the seats are not available, the system may omit the seats, or highlight them as not being available.

### Cross-Event Searching by Seats

The system may also provide a way for users to search for other events where a specific set of seats are available. The set of seats may be a set that the user previously purchased, or a set that the user is considering. In addition, the system may search for any events where those seats are available, or only events where the available seats meet certain criteria (e.g. fit within the user's minimum and maximum price).

For example, suppose a user buys 2 tickets in section 100 row B, and really liked the seats. They may be interested in other games where they could get those same seats. The system may provide an option for “show me other games where I can buy these seats”, with a summary of pricing information for those other events.

The system may also broaden the search by finding “comparable” seats. For example, if section 100 row B was not available, the system might present seats in section 100 row D as an alternative. The system could use the methods described in the “large group search” section (e.g. physical distance, etc.) to find seats that are nearby.

### Seat Summary Report

Users buying for a group typically want to summarize the seat information for the other users/customers that will be attending. To support this, the system may provide a single page summarizing the seating information, including any combination of event information (e.g. performer/team, date, time); venue location, directions to the venue; seat location on the venue map; detailed seat information; photo view from the seat or section; any other descriptive information about the seat (such as user comments, ratings, reviews, etc.); pricing information (seat price, average seat price, price in the section, etc.); comments added or provided by the buying user; the pricing information may be omitted.

The seat summary report may be implemented as a Web page, with a unique URL that the buying user can email to other customer/users. It could also be rendered as a PDF file that could be sent as an email attachment.

The system may also provide a way for the buying user to enter email addresses of all of the attendees, and have the system automatically send the summary report (as a URL, html email or a PDF) to the user attendees.

### Implementation Methods

The user interface methods described here may be implemented using any available technology, including client-side (e.g. Java or .NET) or Web-based (e.g. AJAX, Flash/Flex, Silverlight, etc.)

This section describes a specific methods for implementing an interactive venue map with AJAX. AJAX implementations have the advantage of not requiring any additional downloads or plugins to work.

### Server-Client Interaction

AJAX implementations typically used asynchronous (the “A” in AJAX) back to a server (typically using XML) to fetch data and perform operations on the server as needed. This approach has the disadvantage of the latency of performing server requests, and the associated impact on the responsiveness of the application.

Another approach is to compile some (or all) of the needed application data into the JavaScript code, on the fly, from the server. When the data is of a reasonable size for a Web page down load, this approach eliminates the need for server requests to fetch additional data, improving the responsiveness for the user. For the interactive Web pages for seat selection, this approach could be used as follows:

User selects an event (e.g. date, venue, performer), via some existing interface (e.g. Web interface)

The server builds a list of all available tickets for that event. The list is “de duped”, by removing duplicate listings for the same seats. The system would normally remove the higher-priced listings, as most users are shopping for the lowest price tickets.

The server then compiles this available ticket list into the JavaScript code that's about to be downloaded to the user's Web browser. The JavaScript code would also include all of the other code needed to provide the interactivity described in the user interface methods, above.

Other methods include hybrid implementations, with aggregated data. For example, the server may aggregate or summarize the list of available tickets (e.g. down to the section level). When the user selects a section, the system may then use traditional AJAX methods to fetch the section level detail from the server.

### Venue Map Highlighting

This section describes AJAX methods for presenting a venue map with highlighted sections. The general idea is to have a “backdrop” venue image that provides an underlying view of the venue. Then, specific images are provided for each section in the venue, and these images are positioned over the venue “backdrop” venue image with absolute positioning. In one implementation, there is only one version of the section image to indicate “highlighted” or “selected”, and the image is present or marked visible when that section is highlighted.

In another implementation, there may be multiple versions of each section image, used to indicate different contexts for each section. For example, there may be four different visualizations for each section: no tickets available at all; tickets available below the user's min price; tickets available within the user's price range, tickets available above the user's maximum price.

The section images may use a transparent “color” for areas outside of the section, so that pixels in the underlying back group venue image are visible. The system may also use various opacity settings to indicate different things on the venue map. For example, a section with tickets available above the user's maximum price might be more or less opaque, depending on how much above the user's maximum price the tickets in that section were.

Image collapsing. This approach has the disadvantage of requiring a large number of images to be loaded into the browser. If a venue has 100 sections, and there are 4 different visualizations for each section, then 400 images are needed.

Since the images are small, it is possible to combine the small section images into a large master image. As long as the section images are arranged within the large image so that they are non-overlapping (e.g. in a vertical strip, horizontal strip, or in an approximate grid), individual section images can be selected out of the large image and placed at the appropriate location using absolute or relative positioning with respect to the “backdrop” venue map. Existing Web CSS methods can be used to ensure that only the particular section image is visible at the right location on the venue map. In other words, each section would have a fragment of CSS to select the right section image out of the master image and place it on the venue backdrop image.

Implementation methods. These general methods may be implemented by having a specification file that defines the geometry of the venue, and the geometry of the individual sections. The system would then take this venue specification file and automatically generate the “backdrop” image for the venue; the master section images (as a single image, or different images for each section highlighting type); the CSS code need to render the venue maps, with the fragments needed to place each section properly from the master section image.

The generation of these files could be done in a batch-mode on the server, or on-the fly as needed for user requests.

If multiple zoom-levels are supported, the system would generate this set out outputs for each zoom level supported.

1. A method for assisting users select seats for an event, comprising:
providing a user interface;
utilizing the user interface to select a seat; and
wherein the user interface includes at least one of, a price range slider, a number of seat selector, a seat ranking selector, a table of available seats and a venue map.
